(19) United States
(12) Patent Application Publication
(10) Pub. No.: US 2025/0214840 A1
(43) Pub. Date: Jul. 3, 2025

(54) PROCESS FOR MAKING A DOPED CATHODE ACTIVE MATERIAL

(71) Applicant: BASF SE, Ludwigshafen am Rhein (DE)

(72) Inventors: Fabian Seeler, Ludwigshafen am Rhein (DE); Wolfgang Rohde, Ludwigshafen am Rhein (DE); Regina Vogelsang, Ludwigshafen am Rhein (DE); Kerstin Schierle-Arnat, Ludwigshafen am Rhein (DE); Maximilian Rang, Ludwigshafen am Rhein (DE); Kathrin Michel, Ludwigshafen am Rhein (DE); Carsten Sueling, Ludwigshafen am Rhein (DE)

(73) Assignee: BASF SE, Ludwigshafen am Rhein (DE)

(21) Appl. No.: 18/849,608

(22) PCT Filed: Mar. 20, 2023
(86) PCT No.: PCT/EP2023/057018

§ 371 Date: Sep. 23, 2024

(30) Foreign Application Priority Data
Mar. 25, 2022 (EP) 22164292.9

(51) Int. Cl. C01B 25/45; H01M 10/54

(52) U.S. Cl. CPC C01B 25/45; H01M 10/54; C01P 2002/54; C01P 2004/51; C01P 2004/61; C01P 2004/84; C01P 2006/40

(57) ABSTRACT

Process for the manufacture of a fluoride doped cathode active material with olivine crystal structure wherein said process comprises the steps of (a) providing a source of phosphate, source of metal other than lithium selected from iron and, optionally, of at least one further element M¹ selected from titanium, vanadium, nickel, yttrium, copper, magnesium, zinc, aluminum, cobalt and manganese, wherein at least 55 mol-% of said metal other than lithium is iron, and wherein said source may be formed from one or more compounds, (b) providing a source of lithium that contains 0.01 to 2.5% by weight of fluoride, uniformly dispersed within said source of lithium, wherein the source of lithium is selected from lithium hydroxide and lithium carbonate, (c) mixing said source of phosphate, of transition metal with said fluoride-containing source of lithium and with additional source of lithium containing less fluoride, and, optionally, with hydrocarbon, (d) optionally, performing a reaction between at least two components of the mixture from step (c), thereby obtaining an adduct, (e) treating the mixture obtained from step (c) or the adduct from step (d) at a temperature in the range of from 400 to 1000° C. under a reducing or inert atmosphere

The present invention is directed towards a process for the manufacture of a fluoride doped cathode active material with olivine crystal structure wherein said process comprises the steps of
(a) providing a source of phosphate, source of metal other than lithium and selected from iron and, optionally, of at least one further element M¹ selected from vanadium, titanium, nickel, cobalt, copper, zinc, magnesium, aluminum, yttrium and manganese, wherein at least 55 mol-% of said metal other than lithium is iron, and wherein said source may be formed from one or more compounds,
(b) providing a source of lithium that contains 0.01 to 2.5% by weight of fluoride, uniformly dispersed within said source of lithium, wherein the source of lithium is selected from lithium hydroxide and lithium carbonate,
(c) mixing said source of phosphate, of transition metal with said fluoride-containing source of lithium and with additional source of lithium containing less fluoride, and, optionally, with hydrocarbon,
(d) optionally, performing a reaction between at least two components of the mixture from step (c), thereby obtaining an adduct,
(e) treating the mixture obtained from step (c) or the adduct from step (d) at a temperature in the range of from 400 to 1000° C. under a reducing or inert atmosphere.

Lithium-ion secondary batteries are modern devices for storing energy. Many application fields have been and are contemplated, from small devices such as mobile phones and laptop computers through car batteries and other batteries for e-mobility. Various components of the batteries have a decisive role with respect to the performance of the battery such as the electrolyte, the electrode materials, and the separator. Particular attention has been paid to the cathode materials. Several materials have been suggested, such as lithium iron phosphates (“LFP”), lithium cobalt oxides (“LCO”), and lithium nickel cobalt manganese oxides (“NCM”). Although extensive research has been performed the solutions found so far still leave room for improvement.

In particular, in many cases the charge and discharge behaviour is not good enough. Although lithium iron phosphate does not contain environmentally dangerous transition metals, lithium iron phosphate has downsides like the low electrical conductivity. For high-performance electrochemical cells, comparably high amounts of conductive carbon need to be added. However, conductive carbon does not make positive contributions to volumetric energy density or higher efficiency in terms of energy delivery. In particular, conductive carbon does not contribute to properties like capacity, cycle stability, energy and the like of electrochemical cells.

Various publications hint at the potential of fluoride doping in LFP may perform the low temperature performance, B. Wu et al., J. New Mat. Electrochem. Synth. 2011, 14, 147, manufactured by reacting iron (+II) oxalate with lithium hydroxide, lithium fluoride and NH₄H₂PO₄. M. Pan et al., J. Solid State Electrochem. 2012, 16, 1615 disclose a method of making doped LFP with NH₄F as source of fluoride. The authors assign signals in the X-ray diffraction spectra to phases like Li₃FeF₆.

It has been found, though, that the above materials are differing strongly from sample to sample.

It was therefore an objective of the present invention to provide a cathode active material with improved stability such as lower capacity fading and improved cycling stability in constant product quality. It was further an objective to provide a process for making a cathode active material with improved stability such as lower capacity fading and improved cycling stability in constant product quality.

Accordingly, the process defined at the outset has been found, hereinafter also referred to as “inventive process” or as “process according to the (present) invention”. The inventive process comprises a sequence of several steps as defined at the outset, hereinafter also defined as step (a), step (b), step (c) etc. The inventive process will be described in more detail below.

The inventive process is a process for making a fluoride doped cathode active material with olivine crystal structure. The olivine crystal structure is found in materials such as LFP, LiFePO₄.

In the olivine crystal structure, iron may be partially replaced by metal M¹ selected from vanadium, titanium, nickel, cobalt, copper, zinc, magnesium, aluminum, yttrium and manganese, and from combinations of at least two of the aforementioned.

In one embodiment of the present invention, cathode active material made according to the inventive process is characterized by the general formula:

LiFe₍₁₋ₓ₎M¹ₓ(PO₄)_{1-y}F_{3y}
x is in the range of from zero to 0.45, and wherein y is in the range of from 0.0002 to 0.03,
M¹ is selected from Y, Cu, Zn, Mg, Al, Ni, Ti, V, Co and Mn and from combinations of at least two of the aforementioned, preferably from Ni, Co, Mn and V.

In one embodiment of the present invention, above general formula is referring to the electrically neutral state of cathode active material made according to the inventive process.

Such cathode active material is in the form of agglomerates of primary particles, such agglomerates having an average diameter (d50) in the range of from 1 μm to 16 μm, preferably 2 to 10 μm, more preferably 2 to 5 μm, even more preferably 4 to 5 μm. Although a D50 value is—strictly speaking—the median value it is often referred to as average particle diameter (D50).

In one embodiment of the present invention, cathode active material made according to the inventive process is coated with a layer of carbon between the primary crystallites (primary particles), and on the surface of the secondary particles. The mean particle diameter (D50) in the context of the present invention refers to the median of the volume-based particle diameter, as can be determined, for example, by light scattering, especially by LASER scattering technologies, for example at a pressure in the range of from 0.5 to 3 bar.

In one embodiment of the present invention, primary particles of cathode active material made according to the inventive process have an average diameter in the range from 1 to 2000 nm, preferably from 10 to 1000 nm, particularly preferably from 50 to 500 nm, even more preferably 80 to 270 nm. The average primary particle diameter can, for example, be determined by SEM or TEM, or by XRD methods. Such XRD methods preferably use the Scherrer Equation where the peak width is inversely proportional to crystallite size.

Many elements are ubiquitous. For example, sodium, copper and chloride are detectable in certain very small proportions in virtually all inorganic materials. In the context of the present invention, proportions of less than 0.01% by weight of cations or anions are disregarded. A doped cathode active material with olivine crystal structure which comprises less than 0.01% by weight of sodium is thus considered to be sodium-free in the context of the present invention.

Step (a) includes source of phosphate, source of metal other than lithium and selected from iron and, optionally, of at least one further element M¹ as defined above, wherein at least 55 mol-% of said metal other than lithium is iron, the percentage referring to the transition metal content, and wherein said source may be formed from one or more compounds. Preferably, 70 to 99 mol-% or 100 mol-% of transition metal are iron.

Said source of transition metal may contain the transition metals in the “right” oxidation state. In other embodiments, at least one of the transition metals are in too high an oxidation state, for example iron may be in the oxidation state of +III. In such embodiments, a reducing agent needs to be applied, for example in step (e) or in a step (d), or at least one of the other components selected from the source of phosphate is a reducing agent.

Suitable sources of phosphate are phosphoric acid H₃PO₄, phosphorous acid H₃PO₃/P(OH)₃ as free acid or partially neutralized with ammonia, ammonium hydrogen phosphate NH₄H₂PO₄, (NH₄)₂HPO₄, and phosphate. Phosphorous acid may serve as a reducing agent and is then reacted to phosphate.

In one embodiment of the present invention, a reducing agent is provided in step (a) as well that is not a source of phosphate, for example ascorbic acid or lactic acid or hydrazine or a sugar compound like glucose. Some polymers such as polypropylene may serve as a reducing agent as well. Ascorbic acid or lactic acid or polymers may then at least partially be converted to carbon and deposited as a coating of said cathode active material.

Cathode active materials with olivine crystal structure can be manufactured according to various methods, for example by solid state methods or by precipitation methods, and the source of transition metal and phosphorous is then selected accordingly.

For example, step (a) may be performed by
(a1) combining aqueous solutions of iron(+III) salt, a (hydrogen)phosphate of ammonium and a reducing agent, or
(a2) combining an aqueous slurry of an iron compound selected from Fe₂O₃, Fe₃O₄, FeOOH and Fe(OH)₃ with a reducing agent and a source of phosphate, or
(a3) combining an aqueous solution of iron(+III) salt, a source of phosphate, and optionally, at least one reducing agent and polyethylene glycol, or
(a4) providing a solution of an Fe(+II) compound in an organic solvent and a solution of H₃PO₄ in a solvent miscible with water, for example NMP (N-methyl pyrrolidone), or
(a5) mixing an oxalate of Fe(+II) and an ammonium dihydrogene phosphate in the presence of a C₁-C₆-alkanol or polyethyleneglycol,
(a6) synthesizing FePO₄, with an average particle diameter in the range of from 1 to 16 μm.

The embodiments are described at this point in more detail.

In one embodiment, cathode active materials with olivine crystal structure can be made by a gelling method. Gelling methods can enable the control of the structure of a material on a nanometer scale from the earliest stages of syntheses. In such embodiments, in step (a1) an aqueous solution containing a water-soluble iron(III) salt such as Fe(NO₃)₃ or Fe₂(SO₄)₃, a phosphate source such as NH₄H₂PO₄ and a reducing agent such as ascorbic acid and, optionally, at least one water-soluble compound of M¹, such as Co(NO₃)₂, Mn(NO₃)₂, Ni(NO₃)₂, VO(NO₃)₂, VOCl₂, VOCl₃, ZnCl₂, Zn(NO₃)₂, Mg(NO₃)₂, Cu(NO₃)₂, and the like, is combined with a source of lithium according to step (c), vide supra, is then gelled by evaporation of the water. A xerogel will be obtained that is then dried at temperatures of 300 to 400° C., then mechanically treated, for example milled, and again dried at 450 to 550° C., followed by calcination at 700 to 825° C., preferably under an atmosphere of hydrogen. The reducing agent, preferably ascorbic acid, can also serve as carbon source.

In the context of the present invention, the term “water soluble” refers to compounds that have a solubility in water at 20° C. of at least 50 g/l. The term “water-insoluble” then refers to compounds with a solubility in water at 20° C. of less than 0.1 g/l. Compounds with a solubility in between are called “partially water-soluble” or “moderately water-soluble”.

In another embodiment, cathode active materials with olivine crystal structure can be synthesized under hydrothermal conditions starting from a water-insoluble iron compound as source of iron. In such an embodiment, in step (a2) an aqueous slurry of a water-insoluble iron(III) compound such as Fe₂O₃, Fe₃O₄, FeOOH, or Fe(OH)₃ is mixed with at least one reducing agent such as hydrazine, hydrazine hydrate, hydrazine sulphate, hydroxyl amine, a carbon-based reducing agent such as a primary or secondary alcohol, a reducing sugar, or ascorbic acid, or a reductive phosphorus compound such as H₃PO₃ or an ammonium salt thereof, is prepared. A carbon source such as graphite, soot or active carbon can be added. In case the reducing agent does not bear any phosphorous atom, a phosphate source is added, such as phosphoric acid, ammonium phosphate or ammonium (di)hydrogen phosphate, especially (NH₄)₂HPO₄ or NH₄H₂PO₄. Combinations of H₃PO₃ or an ammonium salt thereof and a phosphate source are feasible as well. The slurry so obtained is mixed with a source of lithium, step (c), and then reacted at a temperature in the range of from 100 to 350° C., preferably for a period of time in the range of from 1 to 24 hours. The reaction can be performed at a pressure in the range of from 1 to 100 bar. The water is then removed, followed by calcination, for example at 700 to 900° C., preferably under an atmosphere of hydrogen.

In another embodiment, cathode active materials with olivine crystal structure can be synthesized under hydrothermal conditions starting as step (a3) from a water-soluble iron compound as source of iron. In such an embodiment, in step (a3) an aqueous solution of a water soluble iron(II) compound such as FeSO₄·7H₂O or of a water soluble iron(III) compound such as Fe₂(SO₄)₃·7H₂O is mixed with a source of lithium obtained from step (c), and with a phosphorous compound such as H₃PO₄, (NH₄)₃PO₄·3H₂O, NH₄H₂PO₄, or (NH₄)₂HPO₄, with or without adding a reducing agent, such as ascorbic acid, and/or with or without adding polyethylene glycol (PEG). The solution so obtained is then processed hydrothermally at 120 to 190° C., preferably above 175° C., thereby making an adduct. After the hydrothermal treatment, in most cases the powder so obtained will be treated at higher temperature, for example in the range of from 600 to 800° C.

In another embodiment, cathode active materials with olivine crystal structure can be synthesized in a sol-gel process. In such an embodiment, in step (a4) a solution of a water-soluble iron(II) compound such as Fe(acetate)₂ and H₃PO₄ in at least one organic solvent such as DMF (N,N-dimethyl formamide) is being prepared and combined with a source of lithium, step (c). The organic solvent(s) are then removed, preferably by evaporation. The residue is then heated stepwise to 700° C. and then calcined at temperatures in the range of from 750 to 850° C. under a reducing atmosphere, for example under hydrogen.

In another embodiment, cathode active materials with olivine crystal structure can be synthesized from oxalate, such as iron oxalate. Iron oxalate can be provided, step (a5) in a solid state process, by preparing a stoichiometric mixture of FeC₂O₄·2H₂O with NH₄H₂PO₄, in the presence of alcohol, and with a source of lithium, step (c) by ball-milling or by using high shear mixer. A carbon source such as polyvinyl alcohol (PVA) or glucose is added and the resultant material is sintered, for example at 600 to 800° C. under reducing atmosphere.

In another embodiment, iron oxalate can be employed for the soft chemistry—rheological phase reaction method, wherein in step (a5) FeC₂O₄·2H₂O is combined with a phosphorous compound such as NH₄H₂PO₄ and with a source of lithium, step (c) by thoroughly grinding, under addition of a polymer such as polyethylene glycol as carbon source. The precursor so obtained will then be heated in an inert atmosphere to 400 to 800° C.

In another embodiment, cathode active materials with olivine crystal structure can be synthesized from blends of iron phosphate provided in (a6), without or preferably with water of crystallization, to be mixed in accordance with step (c), by a solid state reaction in the range of from 650 to 800° C. The thermal treatment is under carbothermal conditions, e.g., with sugar as reducing agent, and under reducing or inert atmosphere.

In each of the above embodiments, in step (c) a molar excess of source of lithium with respect to iron or the sum of iron and M¹ may applied be applied.

In formulae of the above compounds, water of crystallization may have been neglected.

In step (b), a source of lithium is provided wherein said source contains 0.01 to 2.5% by weight of fluoride, uniformly dispersed within said source of lithium. Preferred are 0.05 to 0.5% by weight. The percentages are referring to the respective lithium source. Said fluoride is preferably lithium fluoride but may bear counterions other than lithium and stemming from impurities. Preferably, the majority of said fluoride is lithium fluoride. Even more preferred, said fluoride is lithium fluoride.

Sources of lithium are selected from lithium carbonate, lithium oxide, Li₂O, and lithium hydroxide, LiOH, and include hydrates of lithium hydroxide such as, but not limited to LiOH·H₂O. Preferred are lithium oxide, Li₂O, and lithium hydroxide, LiOH.

In said source of lithium, fluoride is uniformly dispersed, preferably as lithium fluoride. The term “uniformly dispersed” means that no separate crystals or accumulations of fluorides or even of LiF may be detected e.g., by X-ray diffraction, particle size distribution, optical microscopy and SEM/EDX (scanning electron microscopy/energy dispersive X-ray spectroscopy). Preferred are particle size distribution and X-ray diffraction and SEM/EDX.

Preferably, said fluoride-containing source of lithium is made by recycling of spent batteries, for example by a recycling process in which lithium carbonate or lithium hydroxide is recovered from a solution of lithium salt that includes a fluoride, for example stemming from an electrolyte such as LiPF₆ or from decomposed fluorine-containing polymer binder.

In one embodiment of the present invention, said recycling process comprises the steps of:
(i) making a black powder, sometimes also named black mass or active mass, from the spent lithium-ion battery by mechanically destroying the battery, followed by thermal treatment,
(ii) treating the black powder with at least one of Ca(OH)₂ or Mg(OH)₂ in the presence of water or a polar solvent other than water, at a temperature of at least 70° C., preferably from 70 to 120° C.,
(iii) separating the solids from the liquid, optionally followed by washing the solid residue with a polar solvent such as water, preferably by filtration, thereby obtaining a solution of lithium hydroxide containing fluoride, and
(iv) removing the water from the solution of lithium hydroxide in one or more steps, for example by evaporation to yield solid LiOH, optionally after purifying the solution.

In another embodiment, steps (i) to (iii) are followed by step (v),
(v) adding CO₂ or any water-soluble carbonate, e.g., Na₂CO₃, to precipitate Li₂CO₃,
(vi) separating the solids from the liquid by a solid-liquid-separation method, for example filtration, optionally followed by washing the solid residue with a polar solvent such as water, thereby obtaining a solid lithium carbonate containing fluoride.

Lithium hydroxide made according to the above recycling process usually contains 0.01 to 1.3% by weight fluoride, referring to the monohydrate of LiOH, preferably 0.05 to 0.5% by weight. Depending on the drying conditions, anhydrous LiOH instead of the monohydrate is obtained. In this case, the above-mentioned characteristic amounts of impurities, which are related to the monohydrate, have a higher concentration, respectively, by a factor of about 1.75 (corresponds to the molar weight of the monohydrate divided by the molar weight of the anhydrate) for 100% water free LiOH.

Lithium carbonate made according to the above recycling process usually contains 0.01 to 1.5% by weight fluoride, preferably 0.05 to 0.5% by weight.

Step (c) includes mixing oxide or (oxy)hydroxide of TM with said fluoride-containing source of lithium and with additional source of lithium containing less fluoride, and, optionally, with one or more dopants based on at least one metal other than lithium. By performing step (c), a mixture is obtained. The expression “said fluoride-containing source of lithium” is the one provided in step (b). The expression “containing less fluoride” refers to a comparison with the source of lithium provided in step (b).

The amounts in which precursor and total source of lithium are mixed will correspond to the desired stoichiometry of the intended cathode active material. Usually, stoichiometric amounts or even a slight excess of lithium with respect to metals other than lithium is chosen.

Step (c) may include mixing with additional source of lithium that contains less fluoride than the source of lithium provided in step (b), for example 1 to 150 ppm, or even below detection level.

Dopants are selected from oxides, hydroxides and oxyhydroxides of Mg, Y, Ti, Zr, W, Nb, Ta, and especially of Al. Lithium titanate is a possible source of titanium. Examples of dopants are MgO, Mg(OH)₂, TiO₂ selected from rutile and anatase, anatase being preferred, furthermore basic titania such as TiO(OH)₂, furthermore Li₄Ti₅O₁₂, ZrO₂, Zr(OH)₄, Li₂ZrO₃, Nb₂O₃, Ta₂O₅, Li₂WO₄, WO₃, MoO₃, Li₂MoO₄, yttria, Al(OH)₃, Al₂O₃, Al₂O₃·aq, and AlOOH. Preferred are Al compounds such as Al(OH)₃, α-Al₂O₃, γ-Al₂O₃, Al₂O₃·aq, and AlOOH, and TiO₂ and Zr(OH)₄. Even more preferred dopants are Al₂O₃ selected from α-Al₂O₃, γ-Al₂O₃, and most preferred is γ-Al₂O₃.

In a preferred embodiment, dopant(s) is/are applied in an amount of up to 2.5 mole %, referring to the sum of iron and M¹, preferably 0.1 up to 1.5 mole %.

In one embodiment of the present invention, in step (c) a source of carbon is added as well. Suitable sources of carbon are organic compounds that decompose during the thermal treatment in step (e) under formation of carbon. Suitable sources of carbon are organic polymers such as, but not limited to polyethylene glycol, polypropylene, starch, cellulose. Further examples of sources of carbon are low-molecular weight organic compounds such as lactic acid, mono- and disaccharides such as glucose, fructose, mannose, lactose, and maltose, ascorbic acid—that ma serve as both reducing agent and source of carbon, stearic acid, citric acid, and their ammonium salts. Alkali metals salts other than lithium salts are preferably avoided as source of carbon.

Examples of suitable apparatuses for performing step (c) are high-shear mixers, tumbler mixers, plough-share mixers and free fall mixers.

In one embodiment of the present invention, step (c) is performed at a temperature in the range of from ambient temperature to 200° C., preferably 20 to 50° C.

In one embodiment of the present invention, step (c) has a duration of 10 minutes to 2 hours. Depending on whether additional mixing is performed in step (d) or not, thorough mixing has to be accomplished in step (c).

Mixing of precursor, source of lithium from step (b) and—optional—further source of lithium and/or dopant(s) and source of carbon, if applicable, may be performed all in one or in substeps, for example by first mixing source of lithium containing fluoride and dopant(s) and adding such mixture to a precursor, or by first mixing precursor and source of lithium containing fluoride and then adding dopant and more source of lithium, or by first mixing dopant and precursor and then adding source of lithium containing lithium fluoride and more source of lithium. It is preferred to first mix precursor and both sources of lithium and to then add dopant or source of carbon, as the case may be.

In one embodiment of the present invention, step (c) comprises the two sub-steps
(c1) mixing fluoride-containing source of lithium and fluoride-free source of lithium and, optionally, said dopant(s),
(c2) mixing the mixture obtained from step (c1) with said oxide or (oxy)hydroxide of TM and, if applicable, with said dopant(s) or source of carbon.

In one embodiment of the present invention, the weight ratio of fluoride-containing source of lithium as provided in step (b) and fluoride-free source of lithium is in the range of from 20:1 to 1:20, preferably from 1:1 to 1:20.

Although it is possible to add an organic solvent, for example glycerol or glycol, or water in step (c) it is preferred to perform step (c) in the dry state, that is without addition of water or of an organic solvent.

A mixture is obtained.

In an optional step (d), a reaction is performed between at least two components of the mixture from step (c), thereby obtaining an adduct. In an adduct formation, some reaction has taken place between the source of iron, of phosphate, with source of lithium or with some reducing agent, but the composition of the adduct is not the same as of the targeted cathode active material with olivine structure. In many cases, the source of carbon has not decomposed ni the adduct formation. In many cases, however, some reduction of iron(III) as taken place, at least to a significant extent.

In one embodiment of step (d), said chemical reaction is performed in the presence of a solvent, for example water or a water-miscible solvent such as a C₂-C₄-alkanol or NMP or N-ethyl pyrrolidone (“NEP”). At the end of step (d), the solvent or the water may be removed at least partially, for example by a spray-drying process. Although it is possible to feed a slurry or paste to step (e) it is preferred to feed a powder or moist powder to step (e).

Step (e) includes subjecting the mixture from step (c) or the adduct from step (d), if applicable, to heat treatment, for example at a temperature in the range of from 400 to 1000° C., preferably 600 to 900° C.

In one embodiment of the present invention, the mixture from step (c) or the adduct from step (d) is heated to 400 to 1000° C. with a heating rate of 0.1 to 10° C./min.

In one embodiment of the present invention, the temperature is ramped up before reaching the desired temperature of from 400 to 1000° C., preferably 600 to 900° C. In preferred examples, first the mixture from step (c) is heated to a temperature to 300 to 400° C. and then held constant for a time of 10 min to 4 hours, and then it is raised to 650° C. up to 900° C.

In embodiments wherein in step (c) or (d), if applicable, at least one solvent has been used, as part of step (e), or separately and before commencing step (e), such solvent(s) are removed, for example by filtration, evaporation or distilling of such solvent(s). Preferred are evaporation and distillation.

In one embodiment of the present invention, step (e) is performed in a roller hearth kiln, a pusher kiln or a rotary kiln or a combination of at least two of the foregoing. Rotary kilns have the advantage of a very good homogenization of the material made therein. In roller hearth kilns and in pusher kilns, different reaction conditions with respect to different steps may be set quite easily. In lab scale trials, box-type and tubular furnaces and split tube furnaces are feasible as well.

In one embodiment of the present invention, step (e) is performed in inert atmosphere such as nitrogen or a rare gas, or in a reducing atmosphere, for example under hydrogen.

By performing the inventive process, a cathode active material is made that shows excellent stability such as a low capacity fade and a high cycling stability as well as a constant composition.

Another aspect of the present invention is a cathode active material, hereinafter also referred to as inventive cathode active material. Inventive cathode active material may be described by the general formula LiFe₍₁₋ₓ₎M¹ₓ(PO₄)_{1-y}F_{3y} and having an average particle diameter (D50) in the range of from 1 to 16 μm, preferably 2 to 10 μm and more preferably 3 to 5 μm, wherein M¹ is selected from Ni, Ti, V, Y, Al, Mg, Zn, Cu, Co and Mn, and wherein x is in the range of from zero to 0.45, and wherein y is in the range of from 0.0002 to 0.03, and F is uniformly distributed in such cathode active material.

Preferred examples of M¹ are Ni, Ti, V, Co and Mn. More preferably, x is zero.

F as fluoride is uniformly distributed in inventive cathode active materials. This means that F is not accumulated at the outer surface of the secondary particles but is inside of the secondary particles. Some fluoride may be accumulated at the grain boundaries of the primary particles but preferably, there are no accumulations. In addition, there are only few to no secondary particles that do not contain fluoride.

Inventive cathode active materials are in particulate form. In one embodiment of the present invention, the mean particle diameter (D50) of inventive cathode active materials is in the range of from 1 to 16 μm, preferably 2 to 10 μm and more preferably 3 to 5 μm. The mean particle diameter (D50) in the context of the present invention refers to the median of the volume-based particle diameter, as can be determined, for example, by light scattering. In one embodiment, the precursor has a monomodal particle diameter distribution. In other embodiments, the particle distribution of the precursor may be bimodal, for example with one maximum in the range of from 1 to 5 μm and a further maximum in the range of from 7 to 16 μm.

The particle shape of the secondary particles of inventive cathode active materials is preferably spheroidal, that are particles that have a spherical shape. Spherical spheroidal shall include not just those which are exactly spherical but also those particles in which the maximum and minimum diameter of at least 90% (number average) of a representative sample differ by not more than 10%.

In one embodiment of the present invention, inventive cathode active materials are comprised of secondary particles that are agglomerates of primary particles. Preferably, said precursor is comprised of spherical secondary particles that are agglomerates of primary particles. Even more preferably, said precursor is comprised of spherical secondary particles that are agglomerates of spherical primary particles or platelets.

In one embodiment of the present invention, inventive cathode active materials have a particle diameter distribution span in the range of from 0.5 to 0.9, the span being defined as [(D90) -(D10)] divided by (D50), all being determined by LASER analysis. In another embodiment of the present invention, said precursor may have a particle diameter distribution span in the range of from 1.1 to 1.8.

In one embodiment of the present invention, inventive cathode active materials further contain carbon in electrically conductive modification, in brief also referred to as C. C can be selected from soot, active carbon, carbon nanotubes, graphene, and graphite. C can be added as such during preparation of electrode materials according to the invention, or it can be manufactured in situ together with cathode active materials with olivine crystal structure, by decomposition of the source of carbon during step (e).

In one embodiment of the present invention, the amount of C is in the range of 1 to 8% by weight, referring to cathode active materials with olivine crystal structure, preferably at least 2% by weight.

In one embodiment of the present invention, the surface (BET) of inventive cathode active materials is in the range of from 5 to 35 m²/g, preferably 7 to 15 m²/g.

In one embodiment of the present invention, inventive cathode active materials are in the form of agglomerates of primary particles, such agglomerates having an average diameter (d50) in the range of from 1 μm to 10 μm, preferably 2 to 5 μm, even more preferably 4 to 5 μm.

In one embodiment of the present invention, inventive cathode active materials with olivine crystal structure is coated with a layer of C between the primary crystallites (primary particles), and on the surface of the secondary particles. Said layer may be incomplete or complete.

In one embodiment of the present invention, C has an average primary particle diameter in the range from 1 to 500 nm, preferably in the range from 2 to 100 nm, particularly preferably in the range from 2 to 50 nm, very particularly preferably in the range from 2 to 4 nm or less.

A further aspect of the present invention refers to electrodes comprising at least one particulate cathode active material according to the present invention. They are particularly useful for lithium-ion batteries. Lithium-ion batteries comprising at least one electrode according to the present invention exhibit a good cycling behavior/stability. Electrodes comprising at least one particulate cathode active material according to the present invention are hereinafter also referred to as inventive cathodes or cathodes according to the present invention.

Specifically, inventive cathodes contain
(A) at least one inventive cathode active material,
(B) carbon in electrically conductive form, added after manufacture of cathode material (A) or made in situ,
(C) a binder material, also referred to as binders or as binders (C), and, preferably,
(D) a current collector.

In a preferred embodiment, inventive cathodes contain
(A) 80 to 98% by weight inventive particulate cathode active material,
(B) 1 to 17% by weight of carbon,
(C) 1 to 15% by weight of binder,
   percentages referring to the sum of (A), (B) and (C).

Cathodes according to the present invention can comprise further components. They can comprise a current collector, such as, but not limited to, an aluminum foil. They can further comprise conductive carbon and a binder.

Cathodes according to the present invention contain carbon in electrically conductive modification, in brief also referred to as carbon (B). Carbon (B) can be selected from soot, active carbon, carbon nanotubes, graphene, and graphite, and from combinations of at least two of the foregoing.

Suitable binders (C) are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol-% of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol-% of copolymerized propylene and up to 50 mol-% of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight M_{w} in the range from 50,000 to 1,000,000 g/mol, preferably to 500,000 g/mol.

Binder (C) may be cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to inventive cathode active material. In other embodiments, inventive cathodes may comprise 0.1 up to less than 1% by weight of binder(s).

A further aspect of the present invention is a battery, containing at least one cathode comprising inventive cathode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Non-aqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol-% of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5,000,000 g/mol, preferably up to 2,000,000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

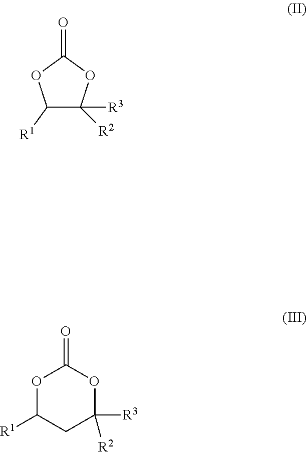

where R¹, R² and R³ can be identical or different and are selected from among hydrogen and C₁-C₄-alkyl, for example methyl, ethyl, n-propyl, isopropyl, n-butyl, isobutyl, sec-butyl and tertbutyl, with R² and R³ preferably not both being tert-butyl. In another embodiment, R¹ in formula (II) is fluorine and R² and R³ are hydrogen.

In particularly preferred embodiments, R¹ is methyl and R² and R³ are each hydrogen, or R¹, R² and R³ are each hydrogen.

Another preferred cyclic organic carbonate is vinylene carbonate, formula (IV).

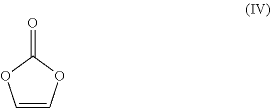

The solvent or solvents is/are preferably used in the water-free state, i.e. with a water content in the range from 1 ppm to 0.1% by weight, which can be determined, for example, by Karl-Fischer titration.

Electrolyte (C) further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In an embodiment of the present invention, batteries according to the invention comprise one or more separators by means of which the electrodes are mechanically separated. Suitable separators are polymer films, in particular porous polymer films, which are unreactive toward metallic lithium. Particularly suitable materials for separators are polyolefins, in particular film-forming porous polyethylene and film-forming porous polypropylene.

Separators composed of polyolefin, in particular polyethylene or polypropylene, can have a porosity in the range from 35 to 45%. Suitable pore diameters are, for example, in the range from 30 to 500 nm.

In another embodiment of the present invention, separators can be selected from among PET nonwovens filled with inorganic particles. Such separators can have porosities in the range from 40 to 55%. Suitable pore diameters are, for example, in the range from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good cycling stability and a low capacity fading.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further provides for the use of batteries according to the invention in appliances, in particular in mobile appliances. Examples of mobile appliances are vehicles, for example automobiles, bicycles, aircraft or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by the following working examples.

### DESCRIPTION OF METHODS

Li within aqueous solutions was determined by optical emission spectroscopy using an inductively coupled plasma (ICP-OES). Instrument: ICP-OES Agilent 5100 SVDV; wavelength: Li 670.783 nm; internal standard: Sc 361.383 nm; dilution factor: Li; calibration: external.

Elemental analysis of fluorine and fluoride was performed in accordance with standardized methods: DIN EN 14582:2016-12 with regard to the sample preparation for the overall fluorine content determination (waste samples); the detection method is an ion selective electrode measurement. DIN 38405-D4-2:1985-07 (water samples; digestion of inorganic solids with subsequent acid-supported distillation and fluoride determination using ion selective electrode).

### Starting Materials:

“Battery grade” LiOH·H₂O, hereinafter also referred to as “LiOH b.g.”, commercially available from Livent, with a fluoride content of less than 5 ppm

LiF is commercially obtained from Sigma Aldrich

### I. Providing Starting Materials for the Calcination

I.1 Synthesis of a LiOH that Contains LiF, Step (b.1)

An amount of ˜1 t mechanically treated battery scrap containing spent cathode active material containing nickel, cobalt and manganese, organic carbon in the form of graphite and soot and residual electrolyte, and further impurities inter alia comprising fluorine compounds, phosphorous and calcium was treated to obtain a reduced mass according to the process described in Jia Li et al., Journal of Hazardous Materials 2016, 302, 97-104. The atmosphere within the roasting system is air whose oxygen reacts with the carbon in the battery scrap to form carbon monoxide, treatment temperature is 800° C.

After reaction and cool down to ambient temperature, the heat-treated material was recovered from the furnace, mechanically treated to obtain a particulate material and analyzed by means of X-ray powder diffraction, elemental analysis and particle size distribution.

The Li content was 3.6 wt.-%, which acts as reference for the following leaching procedure (see below). Fluorine (2.6 wt.-%) is mainly represented as inorganic fluoride (2.3 wt.-%). Particle sizes are well below 1 mm; D50 is determined to be 17.36 μm.

Comparing the obtained XRD pattern with calculated reference patterns of Ni (which is identical with that one of CoₓNi₁₋ₓ, x=0 to 0.6, Co, Li₂CO₃ and LiAlO₂, it can be concluded that Ni is exclusively present as metallic phase, as pure Ni or as an alloy in combination with Co. The whole sample shows typical ferromagnetic behavior when it gets in touch with a permanent magnetic material. As lithium salts, Li₂CO₃ as well as LiAlO₂ are clearly identified by their characteristic diffraction pattern.

Leaching the thermally treated black mass with Ca(OH)₂:

A PFA flask is charged with 30 g of the above-mentioned thermally treated battery scrap material and with 9 g of solid Ca(OH)₂. The solids are mixed. Then, 200 g of water are added with stirring, and the whole mixture is refluxed for 6 hours. After 6 hours, the solid content is filtrated off and filtrate samples are taken and analyzed with regard to Li (c(Li)=0.49 wt.-%) and F (c(F)=0.015 wt.-%).

Solid LiOH from Leached LiOH Filtrate

The filtrate obtained from the experiment described above is then treated by drying to yield solid LiOH as monohydrate, said LiOH containing fluoride. Two different procedures are applied to adjust the fluoride content:
(A) From 150 mL of the filtrate containing 0.49 wt.-% lithium and 0.015 wt.-% fluoride, the water was completely evaporated (40° C., 42 mbar). LiOH·LiF.1 was obtained. An XRD of LiOH·LiF.1 reveals minor impurities of Li₂CO₃. The latter is due to contact with air during most of the process steps. Next to carbon-based impurities, the elemental analysis reveals fluoride as one of the main impurities (c(F)=0.5 wt.-%).
(B) Another 150 mL of a filtrate originating from another LiOH leaching experiment containing 0.49 wt.-% lithium and 0.015 wt.-% fluoride was concentrated by evaporation (40° C., 42 mbar) by a factor of 6 (c(Li)=2.94 wt.-%), filtered and finally dried applying 40° C. and a constant flow of nitrogen for 24 h. An XRD of LiOH·LiF.2 reveals minor impurities of Li₂CO₃. The latter is due to contact with air during most of the process steps. Next to carbon-based impurities, the elemental analysis reveals fluoride as one of the main impurities (c(F)=0.25 wt.-%).
   I.2 Synthesis of a Li₂CO₃ that Contains Fluoride, Step (b.2)

CO₂ was introduced into an LiOH solution containing 2.6 wt.-% lithium and 0.017 wt.-% fluoride for seven hours (ambient conditions, ˜5 L/h). Immediately, white solids became visible. After 7 hours the solids were filtered off, dried and analyzed by XRD as well as by elemental analysis: Li₂CO₃·LiF.2 (Li=19.0 wt.-%, F=0.22 wt.-%). No separate LiF could be detected.

### II. Manufacture of Cathode Active Materials

### II.1 Step (a.1), Mixing Step, Step (c.1), and Calcination, Step (d.1)

“Battery grade” LiOH·H₂O, hereinafter also referred to as “LiOH b.g.”, commercially available from Livent, with a fluoride content of less than 5 ppm is used to be mixed with LiOH·LiF.1.

### Providing a Source of Iron and Phosphate, Step (a.1)

The following ingredients are provided:

| | |
|---|---|
| 280.8 g | α-FeOOH (3.16 mol) calculated as FeOOH |
| 185.6 g | by weight aqueous solution of H₃PO₄ (1.61 mol) |
| 134.2 g | H₃PO₃ (98%) |
| 46.6 g | starch |
| 46.6 g | lactose |

Step (b.1): LiOH b.g. and LiOH·LiF.1, were mixed in a MICROTRON laboratory mixer from Kinematica in a molar ratio LiOH b.g. to LiOH·LiF.1 is 1:1. A mixture is obtained.

### Step (c.1):

A 6-I-reactor equipped with mixer and heater was charged with 4,600 g of H₂O. The water was heated to temperature of 76° C. Then addition of the ingredients was started. First, 75.7 g of the mixture from step (b.1) was added, corresponding to 3.16 mole Li, and dissolved within 20 min. Due to exothermic reaction the solution temperature rose to 80.5° C. Then, the α-FeOOH was added and stirred for another 20 min. Then, H₃PO₄ and H₃PO₃ were added. 20 minutes later, starch and lactose were added in powder form.

Step (d.1): The temperature of the yellow slurry so obtained was 87° C. Then, 500 g of H₂O were added. The slurry so obtained was stirred for 21 hours at 85° C. Then, a solid was isolated by spray-drying. The slurry prepared in the above step was spray-dried using N₂ (25 Nm³/h) as the drying gas, applying the following spray-drying parameters:
Tᵢₙ 295° C.-298° C.
Tₒᵤₜ 135° C.-143° C.
Slurry feed: 724.1 g/h

After spray-drying, 125 g of a yellow spray-powder were obtained, adduct 1.

Step (e.1): 60 g of the spray-powder obtained above were calcined in a rotary quartz-bulb. The rotary bulb was rotating with a speed of 10 rpm. The spray-powder sample was heated from ambient temperature to a temperature of 700° C., with a heating rate of 11.33° C./min. Finally, the material was calcined at a temperature of 700° C. for 1 hour under a stream of N₂ flow (16 NL/h). Then, inventive CAM.1 so obtained as black powder was cooled down to ambient temperature and sieved, (D50): 5 μm.

The electrochemical testing was carried out in coin half cells to show an excellent 1^{st} cycle discharge capacity and cycling stability.

### II.2 Manufacture of a Comparative Cathode Active Material, C-CAM.2

Step (a.1) was repeated, step (a.2).

No step (b.1) was performed.

In step C-(c.2), pure LiOH·H₂O b.g was added. Steps C-(d.2) and C(e.2) were performed analogously. Comparative material was obtained as C-CAM.2.

### II.3 Manufacture of a Comparative Cathode Active Material, C-CAM.3

Step (a.1) was repeated, step (a.3).

Comparative step C-(b.3):

LiOH·H₂O b.g., is mixed with LiF in a weight ratio of 99.66:0.34 in a MICROTRON laboratory mixer from Kinematica. A premix is obtained. As visible from the crystals, there are still LiF crystals in the premix.

Step C-(d.3) and C-(e.3): Step (d.1) is repeated but with the mixture resulting from step C-(c.3). After cooling to ambient temperature, the resultant powder is deagglomerated and sieved through a 50 μm mesh. C-CAM.3 is obtained. Several samples of C-CAM.3 displayed different and inconstant behavior compared to CAM.1 and C-CAM.2.

### III Testing of Cathode Active Material

### III.1 Cathode Manufacture, General Procedure

Positive electrode: PVDF binder (Solef® 5130) was dissolved in NMP (Merck) to produce a 7.5 wt. % solution. For electrode preparation, binder solution (3 wt. %) and carbon black (Super C65, 3 wt.-%) were suspended in NMP. After mixing using a planetary centrifugal mixer (ARE-250, Thinky Corp.; Japan), inventive CAM (or comparative CAM) (94 wt. %) was added and the suspension was mixed again to obtain a lump-free slurry. The solid content of the slurry was adjusted to 61%. The slurry was coated onto Al foil using a KTF-S roll-to-roll coater (Mathis AG). Prior to use, all electrodes were calendared. The thickness of cathode material was 100 μm, corresponding to 6.5 mg/cm². All electrodes were dried at 105° C. for 7 hours before battery assembly.

### III.2 Electrolyte Manufacture

A base electrolyte composition was prepared containing 1 M LiPF₆ in 3:7 by weight ethylene carbonate and ethyl methyl carbonate (EL base 1).

### III.3 Test Cell Manufacture

To produce a cathode (A.1), the following ingredients are blended with one another:
93 g of CAM.1
3 g polyvinylidene difluoride, (c.1) (“PVdF”), commercially available as Kynar Flex® 2801 from Arkema Group,
2.5 g carbon black, (b.1), BET surface area of 62 m²/g, commercially available as “Super C 65L” from Timcal,
1.5 g graphite, (b.2), commercially available as KS6 from Timcal.

While stirring, a sufficient amount of N-methylpyrrolidone (NMP) was added and the mixture was stirred with an Ultraturrax until a stiff, lump-free paste had been obtained.

Cathodes are prepared as follows: On a 30 μm thick aluminum foil the paste is applied with a 15 μm doctor blade. The loading after drying is 2.0 mAh/cm². The loaded foil is dried for 16 hours in a vacuum oven at 105° C. After cooling to room temperature in a hood, disc-shaped cathodes are punched out of the foil. The cathode discs are then weighed and introduced into an argon glove box where they are again vacuum-dried. Then, cells with the prepared discs are assembled.

Electrochemical testing was conducted in “TC2” coin type cells. The electrolyte (C.1) used was a 1 M solution of LiPF₆ in ethyl methyl carbonate/ethylene carbonate (volume ratio 1:1).

Separator (D.1): glass fiber. Anode (B.1): graphite. Potential range of the cell: 2.50 V to 4.0 V.

Inventive electrochemical cell (BAT.1) was obtained.

### III.4 Manufacture of Cathodes and Electrochemical Cells According to the Invention, and of Comparative Cathodes and Electrochemical Cells

For comparative purposes, the above experiment was repeated but inventive (CAM.1) was replaced by an equal amount of C-CAM.2. Comparative electrochemical cell C-(BAT.2) was obtained.

### IV. Testing of Batteries

Electrochemical cells according to the invention and comparative electrochemical cells are each subjected to the following cycling program: Potential range of the cell: 2.50 V to 4.0 V., 0.1 C (first cycle), 0.2 C (from 2^{nd} to 7^{th} cycle). 1 C=160 mA/g. Temperature: 45° C., ambient temperature, and −25° C.

Electrochemical cells according to the invention show an overall very good or better performance compared to comparative electrochemical cells.

The electric conductivity can be determined as follows:

Disc-shaped pellets with a diameter of 0.8 cm and a height between 7 mm (at 100 bar) and 1 to 2 mm (at 500 bar) were formed from (CAM.1). The electric conductivity was measured in accordance with B. J. Ingram et al., J. Electrochem. Soc. 2003, 150, E396.

As a comparison, disc-shaped pellets with a diameter of 1.4 cm and a height of 6 mm were formed from C-(CAM.2) and tested under the same conditions.

Batteries based on inventive cathode active material are superior. In particular, Bat.1 based CAM.1 show increased cycling stability and reduced resistance growth compared to C-Bat.2 based on C-CAM.2, and C-Bat.3 based on C-CAM.3. In particular, several samples of C-CAM.3 showed entirely different electrochemical behavior. Without wishing to be bound by any theory, we assume that some samples of C-CAM.3 contain fluoride and others do not.

1. Process for the manufacture of a fluoride doped cathode active material with olivine crystal structure wherein said process comprises the steps of
(a) providing a source of phosphate, source of metal other than lithium and selected from iron and, optionally, of at least one further element M1 selected from vanadium, titanium, nickel, cobalt, copper, zinc, magnesium, aluminum, yttrium and manganese, wherein at least 55 mol-% of said metal other than lithium is iron, and wherein said source may be formed from one or more compounds,
(b) providing a source of lithium that contains 0.01 to 2.5% by weight of fluoride, uniformly dispersed within said source of lithium, wherein in the source of lithium, no separate crystals or accumulations of fluorides of LiF may be detected by either of X-ray diffraction, particle size distribution, optical microscopy and SEM/EDX, and wherein the source of lithium is selected from lithium hydroxide and lithium carbonate,
(c) mixing said source of phosphate and of metal other than lithium with said fluoride-containing source of lithium and with additional source of lithium containing less fluoride, and, optionally, with hydrocarbon,
(d) optionally, performing a reaction between at least two components of the mixture from step (c), thereby obtaining an adduct,
(e) treating the mixture obtained from step (c) or the adduct from step (d) at a temperature in the range of from 400 to 1000° C. under a reducing or inert atmosphere.

2. Process according to claim 1 wherein said source of phosphate and transition metal is provided by
(a1) combining aqueous solutions of iron(+III) salt, a (hydrogen)phosphate of ammonium and a reducing agent, or
(a2) combining an aqueous slurry of an iron compound selected from Fe2O3, Fe3O4, FeOOH and Fe(OH)₃ with a reducing agent and a source of phosphate, or
(a3) combining an aqueous solution of iron(+III) salt, a source of phosphate, and optionally, at least one reducing agent and polyethylene glycol, or
(a4) providing a solution of an Fe(+II) compound in an organic solvent and a solution of H₃PO₄ in a solvent miscible with water, or
(a5) mixing an oxalate of Fe(+II) and an ammonium dihydrogene phosphate in the presence of a C1-C6-alkanol or polyethyleneglycol, in each case in the absence or presence of a compound of cobalt or manganese.

3. Process according to claim 1 wherein the source of lithium is lithium hydroxide.

4. Process according to claim 1 wherein step (e) is performed at a temperature in the range of from 850 to 1000° C.

5. Process according to claim 1 wherein in step (a), a reducing agent is provided as well.

6. Process according claim 1 wherein step (c) comprises the two sub-steps:
(c1) mixing fluoride-containing source of lithium and fluoride-free source of lithium and, optionally, said dopant(s),
(c2) mixing the mixture obtained from step (c1) with said oxide or (oxy)hydroxide of TM and, if applicable, with said dopant(s) or source of carbon

7. Process according to claim 6 wherein the weight ratio of fluoride-containing source of lithium and fluoride-free source of lithium is in the range of from 1:1 to 1:20.

8. Process according to claim 1 wherein said mixing step (c) is performed in at least two sub-steps
(c1) mixing fluoride-containing source of lithium and fluoride-free source of lithium and, optionally, hydrocarbon,
(c2) mixing the mixture obtained from step (c1) with said source of phosphate and transition metal.

9. Process according to claim 1 wherein step (a1), (a2), (a3) or (a4) is combined with a step (d) that is carried out at a temperature in the range of from 20 to 150° C.

10. Process according to claim 1 wherein said source of lithium in which fluoride is uniformly dispersed is obtained by a recycling process of spent batteries.

11. Process according to claim 1 wherein said fluoride is lithium fluoride.

12. Process according to claim 1 wherein in the source of lithium provided in step (b), no separate crystals or accumulations of fluoride may be detected by particle size distribution and X-ray diffraction and SEM/EDX.

13. Particulate cathode active material according to the general formula LiFe₍₁₋ₓ₎M¹ₓ(PO₄)_{1-y}F_{3y} and having an average particle diameter (D50) in the range of from 1 to 16 μm wherein M¹ is selected from Ni, V, Ti, Co, Y, Al, Mg, Cu, Zn and Mn, and wherein x is in the range of from zero to 0.45, and wherein y is in the range of from 0.0002 to 0.03, and wherein F is uniformly distributed in such cathode active material and not accumulated at the outer surface of the secondary particles of such cathode active material and wherein fluoride is not accumulated at the outer surface of the secondary particles but is inside of the secondary particles.

14. Particulate cathode active material according to claim 13 wherein x is zero.

15. Particulate cathode active material according to claim 13, additionally comprising carbon as a coating.

16. Cathode containing
(A) at least one particulate cathode active material according to claim 13,
(B) carbon in electrically conductive form,
(C) a binder material.

17. Battery containing
(1) at least one cathode according to claim 16,
(2) at least one anode, and
(3) at least one electrolyte.
